(19) United States
(12) Patent Application Publication
(10) Pub. No.: US 2016/0265755 A1
(43) Pub. Date: Sep. 15, 2016

(54) ADJUSTABLE LIGHT BRACKET

(71) Applicant: Chien-Ming LU, Taichung (TW)

(72) Inventor: Chien-Ming LU, Taichung (TW)

(21) Appl. No.: 14/644,645

(22) Filed: Mar. 11, 2015

(51) Int. Cl. F21V 21/14; F21V 21/008; F21V 23/02; F21V 21/03

(52) U.S. Cl. CPC F21V 21/14; F21V 21/03; F21V 21/008; F21V 23/02

(57) ABSTRACT

An adjustable light bracket has a base, a track unit, and a power base. The base has a sliding base, a leading bolt, a leading nut, and a top board. The sliding base has a through hole. The leading bolt is mounted in the through hole and has a bottom abutting plate. The leading nut is mounted around the leading bolt by threads, is located in the through hole, is engaged in the through hole by a peripheral direction of the leading nut, and is moveable along the leading bolt in the through hole. The top board is mounted on the sliding base. The leading nut is limited between the bottom abutting plate and the top board. The sliding base is mounted in the track unit. The power base is mounted in the track unit and located at a position opposite the base.

### BACKGROUND OF THE INVENTION

1. Field of the Invention

The present invention relates to a light bracket, and more particularly to an adjustable light bracket.

2. Description of Related Art

A conventional adjustable light bracket comprises a base, a track unit, and a power base. The base is mounted on a ceiling. The track unit is mounted on a bottom of the base and comprises a track. The track unit is mounted on the base by the track. The power base is mounted in the track unit and comprises a wire extending downwardly.

In use, the track unit can be rotated relative to the base. When the track unit is rotated, the wire is twisted since the wire is mounted in the ceiling, along the track unit, and finally on the power base. When rotations of the track unit are excessive, the wire may be twisted and form a twining state. The wire may be damaged by being over-twisted, which affects a use life of the wire. Further, the power base is mounted in the track unit. When the power base is to be detached from the track unit, the wire needs to be detached first. Therefore, a replacement process of the power base is not easy for a user. The power base is not tightly mounted in the track unit, such that the power base may be loosened relative to the track unit.

### SUMMARY OF THE INVENTION

The main objective of the present invention is to provide an adjustable light bracket to resolve the aforementioned problems.

The adjustable light bracket comprises a connecting base, a track unit, and a power base.

The connecting base comprises a sliding seat, a leading bolt, a leading nut, a top board, and a fixing nut. The sliding seat comprises a through hole formed through the sliding seat. The leading bolt is hollow, is mounted in the through hole, and comprises a bottom abutting plate formed on a bottom of the leading bolt and located under the sliding seat. The leading nut is mounted around the leading bolt by threads, is located in the through hole, is engaged in the through hole by a peripheral direction of the leading nut, and is moveable along the leading bolt in the through hole. The top board is mounted on the sliding seat, is mounted around the leading bolt, and is located above the leading nut, such that the leading nut is limited between the bottom abutting plate and the top board. The fixing nut is mounted around and combined with the leading bolt and abuts the top board.

The track unit is elongated, and the sliding seat is mounted in the track unit. The power base is mounted in the track unit and located at a position opposite the connecting base.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of an adjustable light bracket in accordance with the present invention;

FIG. 2 is an exploded perspective view of the adjustable light bracket in FIG. 1;

FIGS. 3 and 4 are partially enlarged exploded perspective views of the adjustable light bracket in FIG. 1; and

FIGS. 5 and 6 are operational side views in partial section of the adjustable light bracket in FIG. 1.

### DETAILED DESCRIPTION OF PREFERRED EMBODIMENT

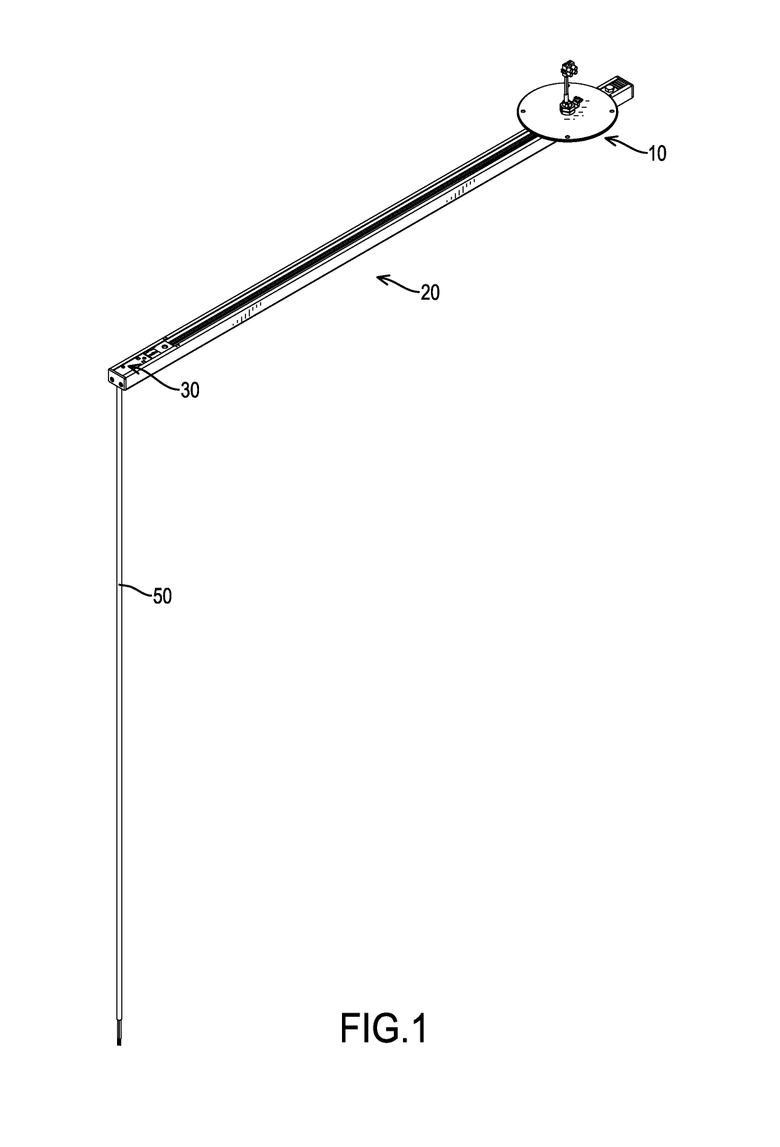

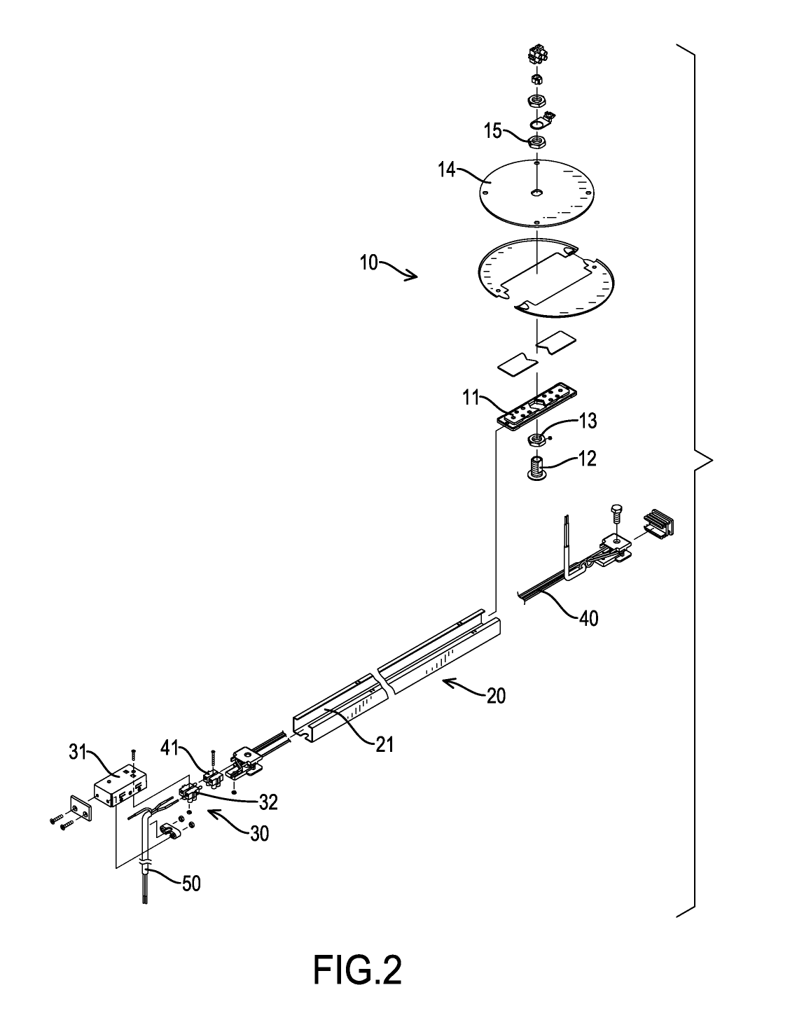

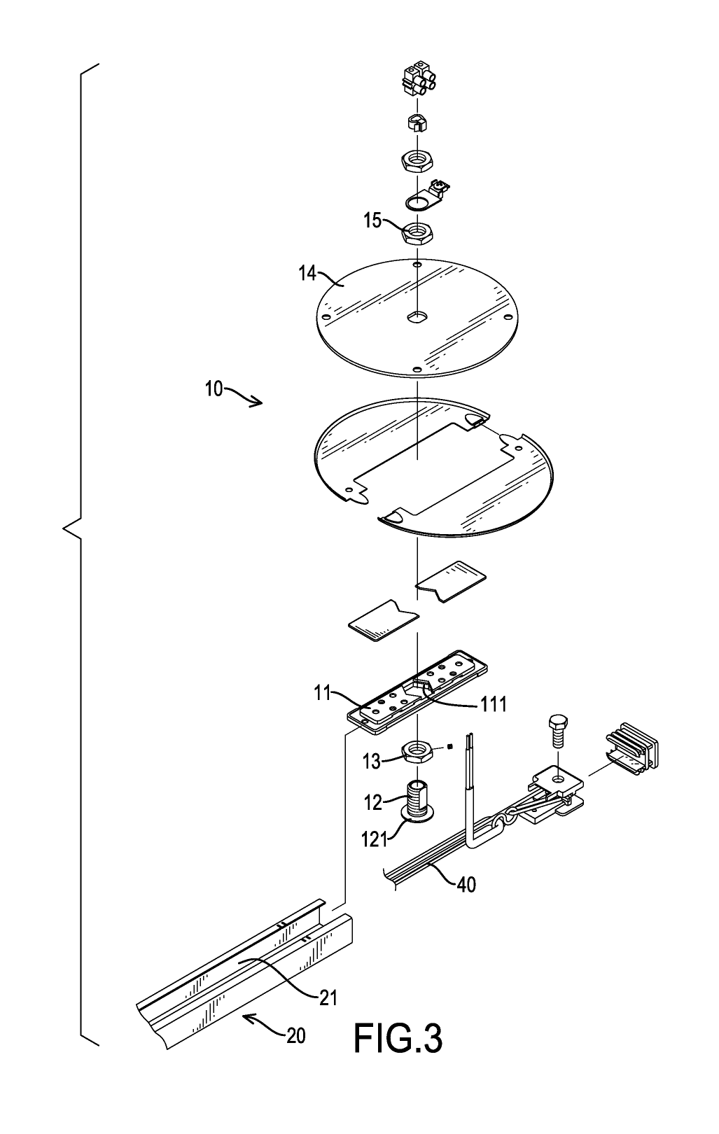

With reference to FIGS. 1 to 3, a preferred embodiment of an adjustable light bracket in accordance with the present invention comprises a connecting base 10, a track unit 20, and a power base 30.

In use, the connecting base 10 is mounted on a ceiling. The connecting base 10 comprises a sliding seat 11, a leading bolt 12, a leading nut 13, a top board 14, and a fixing nut 15. The sliding seat 11 comprises a through hole 111 formed through the sliding seat 11. The through hole 111 is non-circular in shape. Preferably, the through hole 111 is formed as a hexagonal hole. The leading bolt 12 is mounted in the through hole 111, comprises a bottom abutting plate 121 formed on a bottom of the leading bolt 12, and is located under the sliding seat 11. The leading bolt 12 is hollow. In use, a wire is inserted through the leading bolt 12. The leading nut 13 is mounted around the leading bolt 12 by threads and is located in the through hole 111. The leading nut 13 is engaged in the through hole 111 by a peripheral direction of the leading nut 13. The leading nut 13 is moveable along the leading bolt 12 in the through hole 111. The top board 14 is mounted on the sliding seat 11, is mounted around the leading bolt 12, and is located above the leading nut 13. The leading nut 14 is limited between the bottom abutting plate 121 and the top board 14. The fixing nut 15 is mounted around and combined with the leading bolt 12. The fixing nut 15 abuts the top board 14.

The track unit 20 is elongated and comprises a track space 21. The sliding seat 11 is mounted in the track space 21 and can move along the track space 20.

With reference to FIGS. 1 to 4, the power base 30 is mounted in the track space 21 and is located at a position opposite the connecting base 10. The power base 30 comprises a body 31 and an adapter 32. The body 31 is mounted in the track unit 20 and comprises multiple tightening recesses 311 and multiple tightening protrusions 312. The tightening recesses 311 are formed through the body 31, such that multiple plate structures 313 are formed on two opposite sides of the body 31. Each plate structure 313 is bent relative to the body 31 to protrude from the sides of the body 31, and the plate structures 313 abut the track unit 20 tightly, such that a tightening state is formed between the body 31 and the track unit 20. The tightening protrusions 312 are formed on the sides of the body 31 and tightly abut the track unit 20. The adapter 32 is mounted in the body 31 and comprises an adapter portion 321 facing toward the connecting base 10.

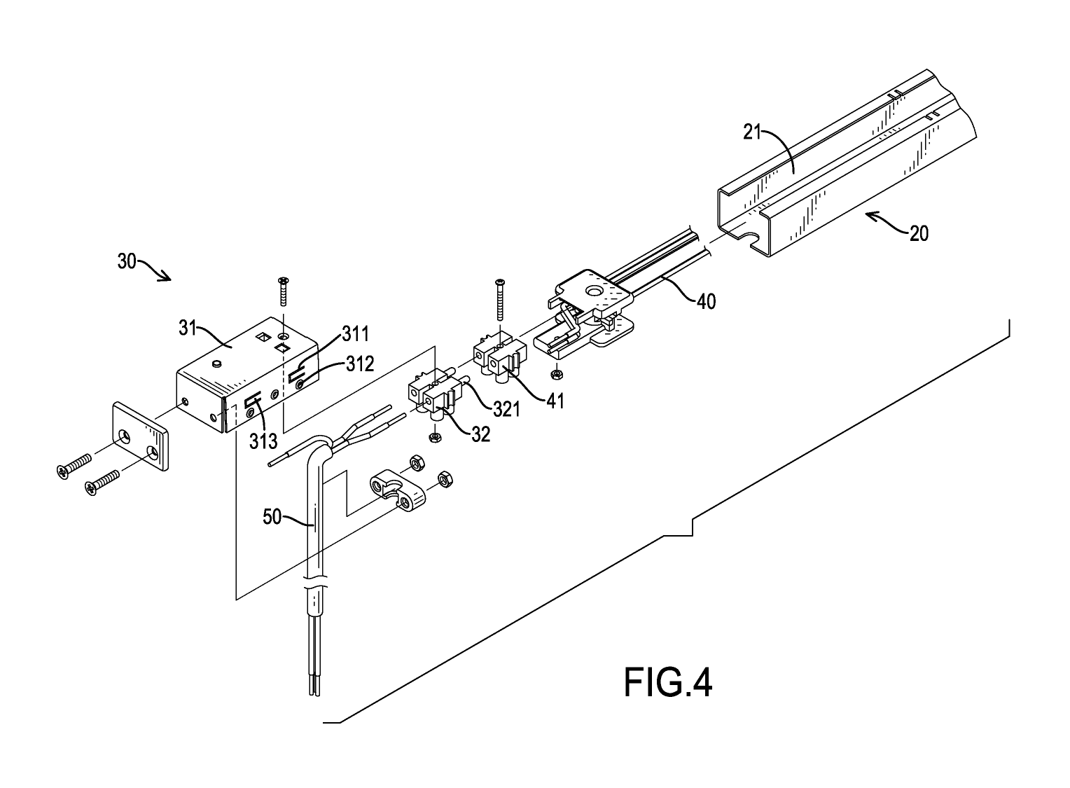

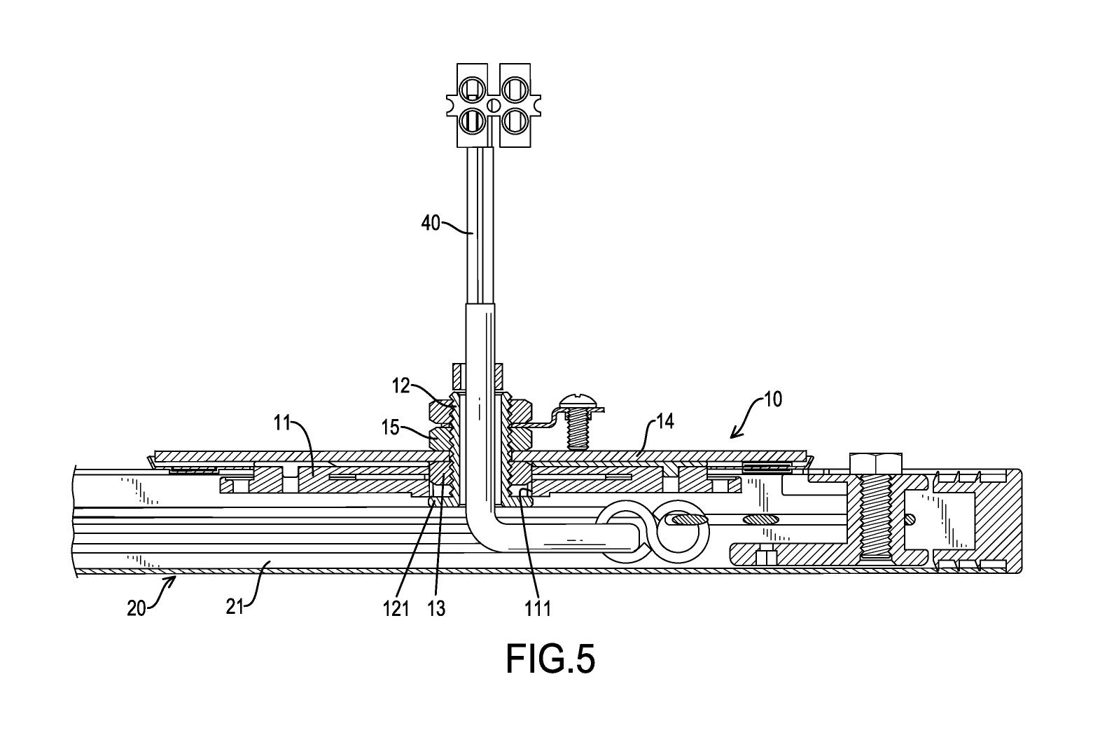

With reference to FIGS. 4 and 5, in use, a wire 40 is mounted in the ceiling and protrudes out of a combination position between the ceiling and the connecting base 10. The wire 40 is first inserted in the leading bolt 12 of the connecting base 10, and then is mounted along the track unit 20. The wire 40 comprises a connection portion 41 mounted on an end of the wire 40 opposite the connecting base 10. The connection portion 41 is detachably and electrically connected with the adapter portion 321 of the power base 30. A light wire 50 is electrically connected with the adapter portion 321 of the power base 30 and extends downwardly below the track unit 20. A light wire is connected with a light at a position opposite the adjustable light bracket.

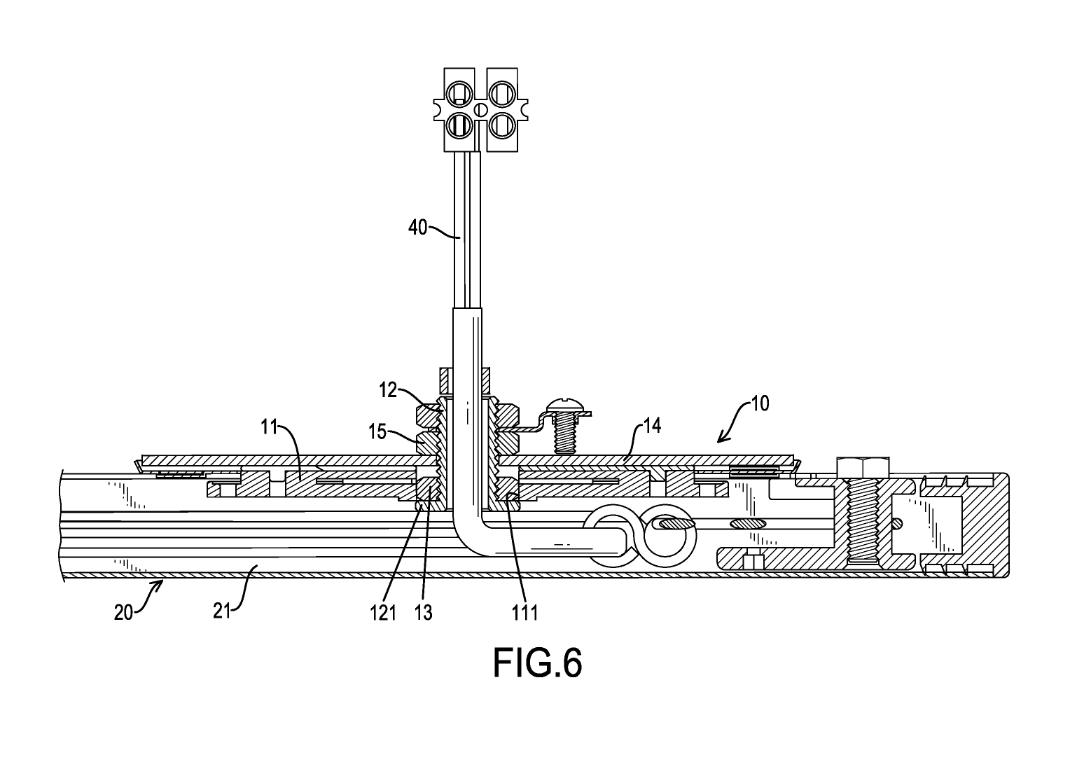

With reference to FIGS. 5 and 6, the track unit 20 is rotated relative to the combination position between the ceiling and the connecting base 10 by a user. The wire 40 is twisted since the adjustable light bracket is rotated. The leading nut 13 is engaged in the through hole 111, such that the leading nut 13 is driven by the sliding seat 11 to move along the leading bolt 12 up and down. When the leading nut 13 moves up and down to abut the bottom abutting plate 121 or the top board 14, the adjustable light bracket is stopped rotating. Therefore, the adjustable light bracket cannot be rotated by the user, such that the user can merely rotate the adjustable light bracket in a reverse direction. The wire 40 cannot be twisted excessively and can be protected from damage to prolong a use life of the wire 40. Furthermore, a length of the leading bolt 12 can be determined according to different demands, and a number of rotations of the adjustable light bracket can vary according to different lengths of the different leading bolts 12.

When the adjustable light bracket needs to be disassembled, the adapter portion 321 can be detached from the connection portion 41, such that the wire 40 and the light can be detached from the power base 30 without affecting the wire 40 mounted in the ceiling. Furthermore, the plate structures 313 and the tightening protrusions 312 can tightly abut the track unit 20 to keep the body 31 from detaching from the track unit 20.

From the above description, it is noted that the present invention has the following advantages:

1. When the adjustable light bracket is rotated, the leading nut 13 can be limited between the bottom abutting plate 121 and the top board 14. When the leading nut 13 abuts the bottom abutting plate 121 or the top board 14, the adjustable light bracket is stopped rotating. Then, the adjustable light bracket needs to be rotated in the reverse direction to keep the wire 40 from damage. Therefore, the use life of the wire 40 can be prolonged.

2. The tightening protrusions 312 and the plate structures 313 can tightly abut the track unit 20 to keep the power base 30 from detaching from the track unit 20, such that a replacement process of the power base 30 is easy for the user. The connecting base 10 can move relative to the track unit 20, such that a position of the track unit 20 relative to the connecting base 10 can be adjusted by the user.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustable light bracket comprising:
a connecting base comprising
a sliding seat comprising a through hole formed through the sliding seat;
a leading bolt which is hollow, the leading bolt mounted in the through hole and comprising a bottom abutting plate formed on a bottom of the leading bolt and located under the sliding seat;
a leading nut mounted around the leading bolt by threads, located in the through hole, engaged in the through hole by a peripheral direction of the leading nut, and being moveable along the leading bolt in the through hole;
a top board mounted on the sliding seat, mounted around the leading bolt, and located above the leading nut, wherein the leading nut is limited between the bottom abutting plate and the top board; and
a fixing nut mounted around and combined with the leading bolt and abutting the top board;
a track unit which is elongated, and the sliding seat mounted in the track unit; and
a power base mounted in the track unit and located at a position opposite the connecting base.

2. The adjustable light bracket as claimed in claim 1, wherein the power base further comprises multiple tightening recesses formed through the power base, such that multiple plate structures are formed on two opposite sides of the power base, and each plate structure is bent relative to the power base to protrude from the sides of the power base to tightly abut the track unit.

3. The adjustable light bracket as claimed in claim 2, wherein the power base further comprises multiple tightening protrusions formed on the sides of the power base and tightly abutting the track unit.

4. The adjustable light bracket as claimed in claim 2, wherein the connecting base is moveable relative to the track unit.
